(19) United States
(12) Patent Application Publication
(10) Pub. No.: US 2018/0321678 A1
(43) Pub. Date: Nov. 8, 2018

(54) Notification System For Automotive Vehicle

(71) Applicant: GM GLOBAL TECHNOLOGY OPERATIONS LLC, Detroit, MI (US)

(72) Inventors: Frank C. Valeri, Novi, MI (US); Glenn Pietila, Howell, MI (US); Scott M. Reilly, Southfield, MI (US)

(21) Appl. No.: 15/586,392

(22) Filed: May 4, 2017

(51) Int. Cl. G05D 1/00; B60Q 9/00; B60W 10/20; B60W 10/04; B60W 10/18; B60W 10/10; B60W 30/18

(52) U.S. Cl. CPC G05D 1/0088; B60Q 9/00; B60W 10/20; B60W 10/04; B60W 10/18; B60W 2710/10; B60W 30/18; B60W 2720/106; B60W 2710/18; B60W 2710/20; B60W 10/10

(57) ABSTRACT

A method of controlling a vehicle having an automated driving system configured to control a vehicle subsystem includes determining an autonomous actuation event for the vehicle subsystem. The method additionally includes detecting a presence of a vehicle occupant. The method also includes, in response to an anticipated change in vehicle dynamics based on the determined actuation event and to the detected presence of the vehicle occupant, providing a notification to the occupant before initiation of the actuation event. The method further includes generating an actuation command based on the actuation event and controlling the vehicle subsystem according to the actuation command via the automated driving system.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

A method of controlling a vehicle according to the present disclosure, having an automated driving system configured to control a vehicle subsystem, includes determining an autonomous actuation command for the vehicle subsystem. The method additionally includes detecting a presence of a vehicle occupant. The method also includes, in response to an anticipated change in vehicle dynamics based on the determined actuation command and to the detected presence of the vehicle occupant, providing a notification to the occupant before initiation of the actuation. The method further includes controlling the vehicle subsystem according to the actuation command via the automated driving system.

In an exemplary embodiment, providing a notification includes providing an audio notification, a visual notification, or a haptic notification.

In an exemplary embodiment, the method additionally includes obtaining a user preference associated with the occupant. The user preference is stored in nontransient data memory. In such an embodiment, providing the notification is in further response to the user preference.

In an exemplary embodiment, the method additionally includes detecting a cabin region associated with the occupant. In such an embodiment, providing a notification includes providing a targeted notification directed at the cabin region associated with the occupant.

In an exemplary embodiment, the method additionally includes determining a notification category based on the autonomous actuation command. In such an embodiment, providing a notification is in further response to the notification category.

A vehicle according to the present disclosure includes an actuator configured to control vehicle steering, acceleration, braking, or shifting. The vehicle additionally includes a sensor configured to detect a presence of an occupant. The vehicle further includes a controller. The controller is configured to determine an autonomous actuation command for the actuator, provide a notification to an occupant indicative of the determined autonomous actuation command, and control the actuator according to the autonomous actuation command.

In an exemplary embodiment, the controller is further configured to control the actuator according to the autonomous actuation command subsequent providing the notification.

In an exemplary embodiment, the notification includes an audio notification, a visual notification, or a haptic notification.

In an exemplary embodiment, the controller is further configured to obtain a user preference associated with the occupant. In such embodiments, the user preference is stored in nontransient data memory, and the controller is further configured to provide the notification in further response to the user preference.

In an exemplary embodiment, the vehicle additionally includes an interior cabin, and the controller is further configured to detect a cabin region associated with the occupant and to provide the notification as a targeted notification directed at the cabin region associated with the occupant.

In an exemplary embodiment, the controller is further configured to determine a notification category based on the autonomous actuation command, wherein providing a notification is in further response to the notification category.

An autonomous driving system for a vehicle according to the present disclosure includes an actuator and at least one controller. The actuator is configured to control vehicle steering, acceleration, braking, or shifting. The controller is programmed to determine a target path, determine an actuation command to maintain the vehicle on the target path, provide a notification to an occupant indicative of an anticipated change in vehicle dynamics associated with the actuation command, and control the actuator according to the actuation command.

In an exemplary embodiment, the controller is further configured to control the actuator according to the autonomous actuation command subsequent providing the notification.

In an exemplary embodiment, the notification includes an audio notification, a visual notification, or a haptic notification.

In an exemplary embodiment, the controller is further configured to communicate with a nontransient data memory device, obtain a user preference associated with the occupant from the nontransient data memory, and provide the notification in further response to the user preference.

In an exemplary embodiment the controller is further configured to detect a cabin region associated with the occupant, and to provide the notification as a targeted notification directed at the cabin region associated with the occupant.

In an exemplary embodiment, the controller is further configured to determine a notification category based on the autonomous actuation command, where providing a notification is in further response to the notification category.

Embodiments according to the present disclosure provide a number of advantages. For example, the present disclosure provides a system and method for cueing an occupant of an autonomous vehicle in advance of a change in vehicle dynamics, thereby increasing passenger comfort and satisfaction.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure; and

FIG. 3 is a flowchart representation of a method of controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

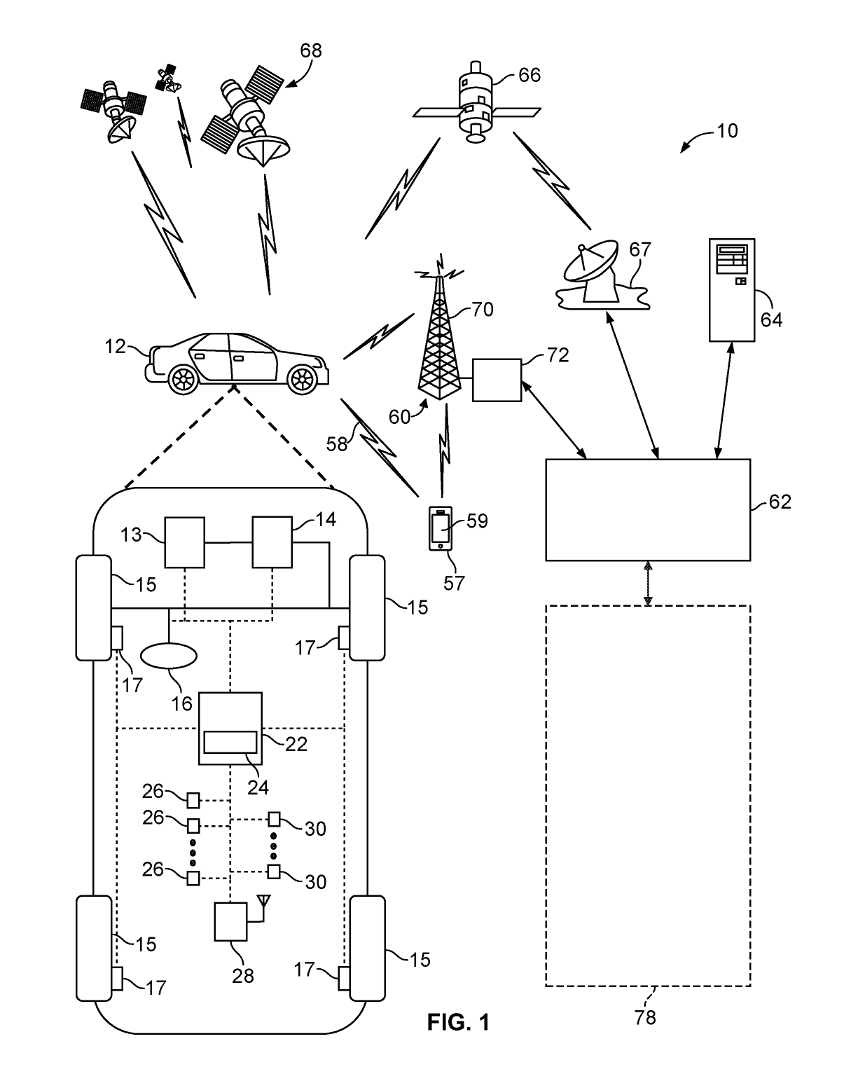

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

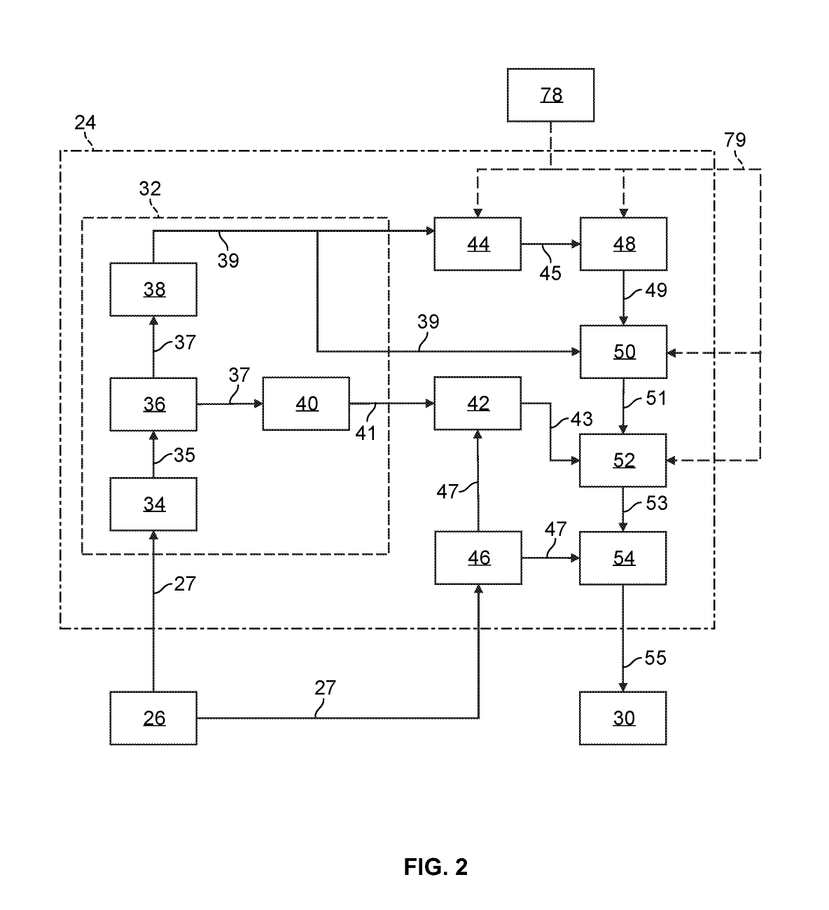

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. As used here, a route refers to the series of roadways to be followed to reach a destination and may be obtained, for example, using a conventional navigational algorithm, while a vehicle path refers to a localized sequence of turns, braking, acceleration, and shifting. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

Occupants in a conventional operator-controlled vehicle are generally able to anticipate changed in vehicle dynamics before those changes occur. Changes in vehicle dynamics refer to changes in vehicle motion such as acceleration in a fore-aft direction, acceleration in a sideways direction, or yawing motions. For example, experienced drivers may intuitively understand the acceleration the driver will experience as a result of turning a steering wheel or depressing a brake pedal. Likewise, passengers may observe behavior of the driver to anticipate changes in vehicle dynamics, as well as observe other indicators of upcoming changes. Such indicators include audio cues such as engine noises and turn signals, as well as vide cues such as observed relative positions of other vehicles or other obstacles proximate the vehicle. However, in a vehicle under the control of an automated driving system, occupants may have less information available with which to anticipate changes in vehicle dynamics. As an example, some autonomous vehicles may not have be provided with an observable steering wheel, accelerator pedal, or brake pedal; moreover, when a vehicle is under the control of an automated driving system occupants may be less attuned to exterior features and thereby less likely to anticipate upcoming changes in vehicle dynamics.

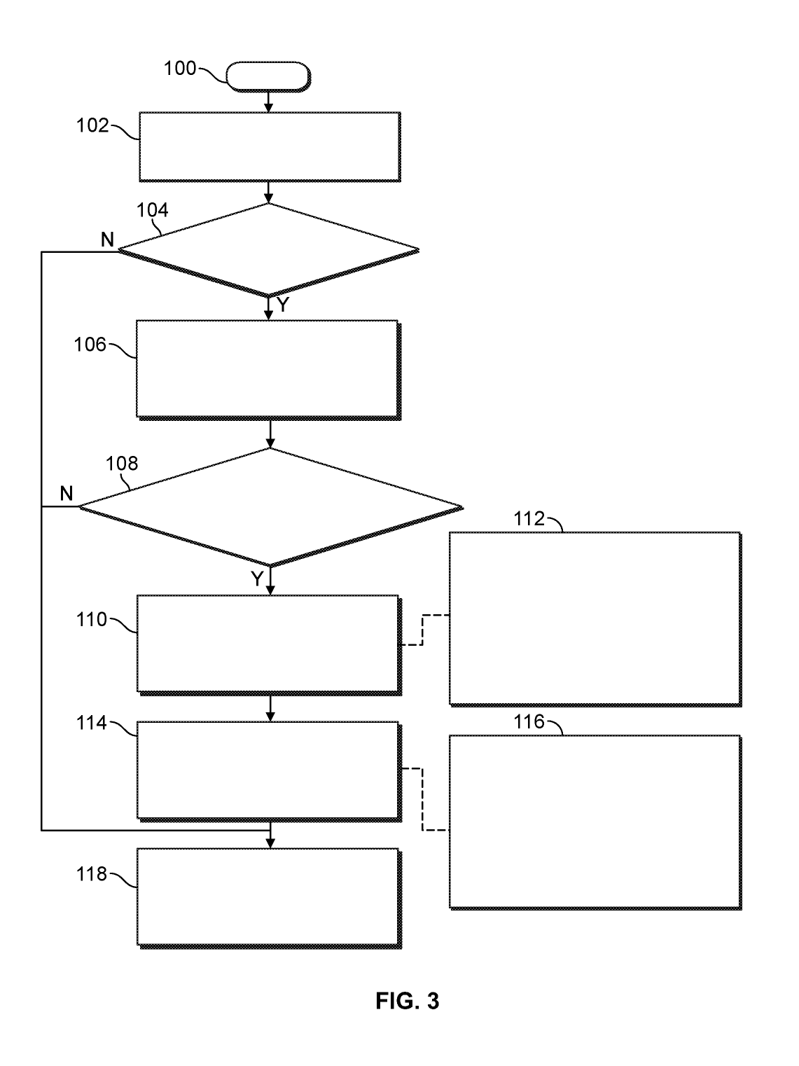

Referring now to FIG. 3, a method of controlling a vehicle according to the present disclosure is illustrated in flowchart form. The algorithm begins at block 100.

Path planning output is generated, as illustrated at block 102. As discussed above with respect to the path planning module 50, path planning output corresponds to a vehicle path to be followed to maintain the vehicle on the desired route while obeying traffic laws and avoiding any detected obstacles.

A determination is then made of whether an occupant is detected, as illustrated at operation 104. This may be performed based on sensor readings from a seat pressure sensor, interior optical or thermal imaging, or other techniques as appropriate.

If the determination of operation 104 is positive, information about the occupant is obtained, as illustrated at block 106. This may include loading one or more user profiles associated with the occupant or occupants, determining a position or positions within the vehicle, other means of obtaining occupant information, or combination thereof. User profile or profiles may be stored in non-transient data memory, e.g. on the mobile device 57 or the computer 64. The user profile or profiles include one or more preferences selected by the user or users with whom the profile is associated. The preferences may include, for example, a notification preference indicating a desired intensity and type of notification. As will be discussed in further detail below, available notification types may include audio, visual, haptic, other notification styles, or combination thereof. The user position within the vehicle may be performed based on sensor readings as discussed above. Other available characteristics associated with the user may also be captured if available. Notably, in some embodiments block 106 may be omitted, such that a general notification may be issued independent of any characteristics or location of the occupant or occupants.

A determination is made of whether a change in vehicle dynamics is anticipated based on the path planning output, as illustrated at operation 108. As discussed above, changes in vehicle dynamics refer to changes in vehicle motion such as acceleration in a fore-aft direction, acceleration in a sideways direction, or yawing motions.

If the determination of operation 108 is positive, the change in vehicle dynamics is classified according to a classification schema, as illustrated at block 110. In an exemplary embodiment, the classification schema distinguishes among changes in vehicle dynamics based on magnitude of change, direction of change, or combination thereof, as illustrated at block 112. The classification schema may also distinguish based on other factors, such as the cause for the change in vehicle dynamics as determined based on vehicle sensors such as LiDAR or GPS. In an exemplary embodiment, the classification schema includes a first category for planned events such as planned turns to maintain a vehicle route, a second category for unplanned events such as a heavy braking event to avoid collisions, and a third category for courtesy notification events. Courtesy notification events refer to relatively small changes in vehicle dynamics for which additional information relating to the cause of the change may be of interest to an occupant, such as pulling over for an emergency vehicle or decelerating due to upcoming traffic congestion. Notably, in some embodiments block 110 may be omitted, such that a general notification may be issued independent of any characteristics or causes for the change in vehicle dynamics.

A vehicle dynamics change notification is then provided to the occupant, as illustrated at block 114. The notification is intended to alert the occupant to the anticipated change in vehicle dynamics. The notification may be provided as an audio notification, visual notification, haptic notification, other style of notification, or combination thereof, as illustrated at block 116. The intensity and type of notification provided may be based on preferences stored in the occupant's user profile, if one was obtained, as also illustrated at block 116. The notification may be targeted at the user's location within the vehicle, if known, as also illustrated at block 116. The notification may also be based on the classification of the change in vehicle dynamics, as also illustrated at block 116. In an exemplary embodiment, the notification may include a skeumorph derived from familiar and conventional vehicle behavior, such as an engine revving sound in advance of an acceleration event. In another exemplary embodiment, the notification may include a spoken description of the upcoming change in vehicle dynamics and the cause of the change.

Vehicle control output is then generated, as illustrated at block 118 and discussed above with respect to the vehicle control module 54. Vehicle actuators are then controlled according to the vehicle control output, as also illustrated at block 118. Occupants are thereby notified of anticipated changes in vehicle dynamics in advance of the change being executed. In an exemplary embodiment, the notification is provided at least 100 ms in advance of the change being executed, e.g. in the 100-1000 ms range, in order to provide adequate time for the occupant to perceive and comprehend the notification. In other embodiments, the notification is provided concurrently with the change being executed. In some embodiments, the timing of the notification may be based on the classification of the change in vehicle dynamics, e.g. by providing notifications for planned events further in advance relative to notifications for unplanned events.

If the determination of operations 104 or 108 are negative, i.e. no change in vehicle dynamics is anticipated or no occupant is detected, then control proceeds directly to block 118. Thus, no notification may be provided if the vehicle is unoccupied or no change in vehicle dynamics is anticipated.

As an example, if the path planning module 50 determines that an acceleration is desired, a notification may be provided to any occupants in advance of the acceleration being executed. In an exemplary embodiment, the notification may include a sound of an engine spooling up and a corresponding vibration. As another example, if the path planning module 50 determines that a deceleration is desired, a notification may be provided to any occupants in advance of the deceleration being executed. In an exemplary embodiment, the notification may include a speech message describing the reasons for the deceleration.

As one of ordinary skill in the art will appreciate, other embodiments of algorithms according to the present disclosure may omit some steps illustrated in FIG. 3, include additional steps, or change the order of the steps.

As may be seen the present disclosure provides a system and method for notifying an occupant of an autonomous vehicle in advance of a change in vehicle dynamics, thereby increasing comfort of the occupant during a ride and increasing customer satisfaction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle having an automated driving system configured to control a vehicle subsystem, the method comprising:
determining an autonomous actuation event for the vehicle subsystem;
detecting a presence of a vehicle occupant;
in response to an anticipated change in vehicle dynamics based on the determined actuation event and to the detected presence of the vehicle occupant, providing a notification to the occupant before initiation of the actuation;
generating an actuation command based on the actuation event; and
controlling the vehicle subsystem according to the actuation command via the automated driving system.

2. The method of claim 1, wherein providing a notification includes providing an audio notification, a visual notification, or a haptic notification.

3. The method of claim 1, further comprising obtaining a user preference associated with the occupant, the user preference being stored in nontransient data memory, wherein the providing a notification is in further response to the user preference.

4. The method of claim 1, further comprising detecting a cabin region associated with the occupant, wherein providing a notification includes providing a targeted notification directed at the cabin region associated with the occupant.

5. The method of claim 1, further comprising determining a notification category based on the autonomous actuation command, wherein providing a notification is in further response to the notification category.

6. A vehicle comprising:
an actuator configured to control vehicle steering, acceleration, braking, or shifting;
a sensor configured to detect a presence of an occupant; and
a controller configured to determine an autonomous actuation event to maintain a vehicle route, provide a notification to an occupant indicative of the determined autonomous actuation event, generate an autonomous actuation command based on the autonomous actuation event, and control the actuator according to the autonomous actuation command.

7. The vehicle of claim 6, wherein the controller is further configured to control the actuator according to the autonomous actuation command subsequent providing the notification.

8. The vehicle of claim 6, wherein the notification includes an audio notification, a visual notification, or a haptic notification.

9. The vehicle of claim 6, wherein the controller is further configured to obtain a user preference associated with the occupant, the user preference being stored in nontransient data memory, and wherein the controller is further configured to provide the notification in further response to the user preference.

10. The vehicle of claim 6, further comprising an interior cabin, wherein the controller is further configured to detect a cabin region associated with the occupant, and to provide the notification as a targeted notification directed at the cabin region associated with the occupant.

11. The vehicle of claim 6, wherein the controller is further configured to determine a notification category based on the autonomous actuation command, wherein providing a notification is in further response to the notification category.

12. An autonomous driving system for a vehicle comprising:
an actuator configured to control vehicle steering, acceleration, braking, or shifting; and
at least one controller programmed to determine a target path, determine an actuation command to maintain the vehicle on the target path, provide a notification to an occupant indicative of an anticipated change in vehicle dynamics associated with the actuation command, and control the actuator according to the actuation command.

13. The autonomous driving system of claim 12, wherein the controller is further configured to control the actuator according to the autonomous actuation command subsequent providing the notification.

14. The autonomous driving system of claim 12, wherein the notification includes an audio notification, a visual notification, or a haptic notification.

15. The autonomous driving system of claim 12, wherein the controller is further configured to communicate with a nontransient data memory device, obtain a user preference associated with the occupant from the nontransient data memory, and provide the notification in further response to the user preference.

16. The autonomous driving system of claim 12, wherein the controller is further configured to detect a cabin region associated with the occupant, and to provide the notification as a targeted notification directed at the cabin region associated with the occupant.

17. The autonomous driving system of claim 12, wherein the controller is further configured to determine a notification category based on the autonomous actuation command, wherein providing a notification is in further response to the notification category.
